(19) United States
(12) Patent Application Publication
(10) Pub. No.: US 2007/0271916 A1
(43) Pub. Date: Nov. 29, 2007

(54) Device for Producing Energy

(76) Inventor: Juhani Jaakko Korhonen, Kuhmo (FI)

Correspondence Address: JOEL D. SKINNER, JR.;SKINNER AND ASSOCIATES, 212 COMMERCIAL ST., HUDSON, WI, 54016, US

(21) Appl. No.: 10/583,001

(22) PCT Filed: Dec. 16, 2004
(86) PCT No.: PCT/FI04/00769

§ 371 Date: Jul. 26, 2007

(30) Foreign Application Priority Data
Dec. 16, 2003 (FI) 20031842

(51) Int. Cl. B60T 11/20

(52) U.S. Cl. 60/562

(57) ABSTRACT

A device for producing energy, using a reservoir (1) filled with liquid or submerged in liquid and at least two moving pistons (3, 3′) which are tightly installed in guides (4) in wall of the reservoir. There are at least two pairs of pistons and in the immediate vicinity of each piston (3) there is a weight (5) that can be moved essentially in the radial direction of the reservoir (1).

The present invention relates to a device for producing energy, and particularly to such a device, with the aid of which it is possible to produce energy economically.

The invention is based on achieving an arrangement that produces energy, with the aid of a pressure difference between a liquid and a gas and related moving pistons and weights.

An arrangement of weights and particularly weights and floats has also been used previously to produce energy, with varying success.

The present invention is intended to create an apparatus, with the aid of which energy can be produced simply and cheaply.

The aforementioned and other advantages and benefits of the present invention are achieved in the manner stated to be characteristic in the accompanying Claims.

The invention is examined in greater detail with reference to the accompanying drawings, which show schematic diagrams of one embodiment of the invention.

Thus:

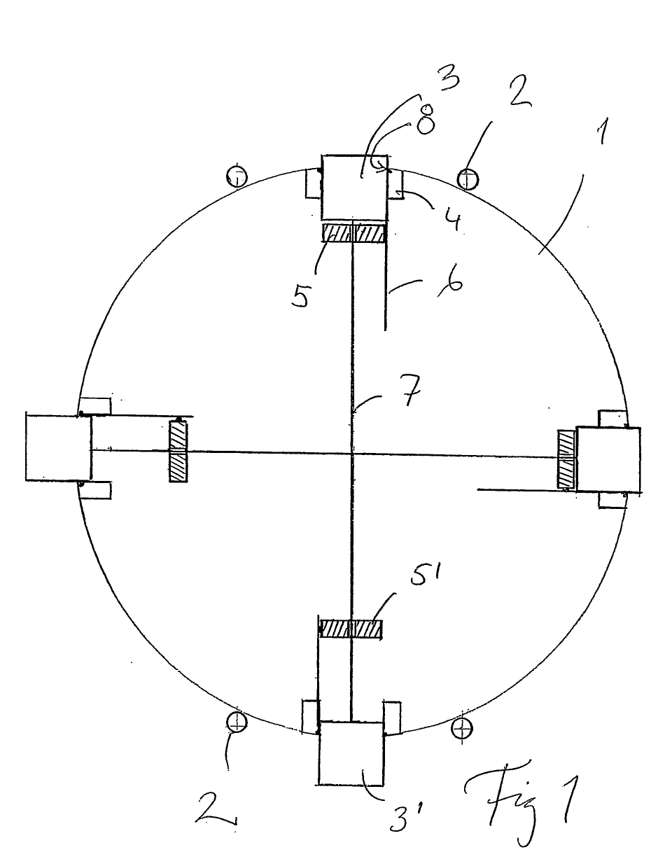

FIG. 1 shows a simplified, schematic diagram of one embodiment of the invention;

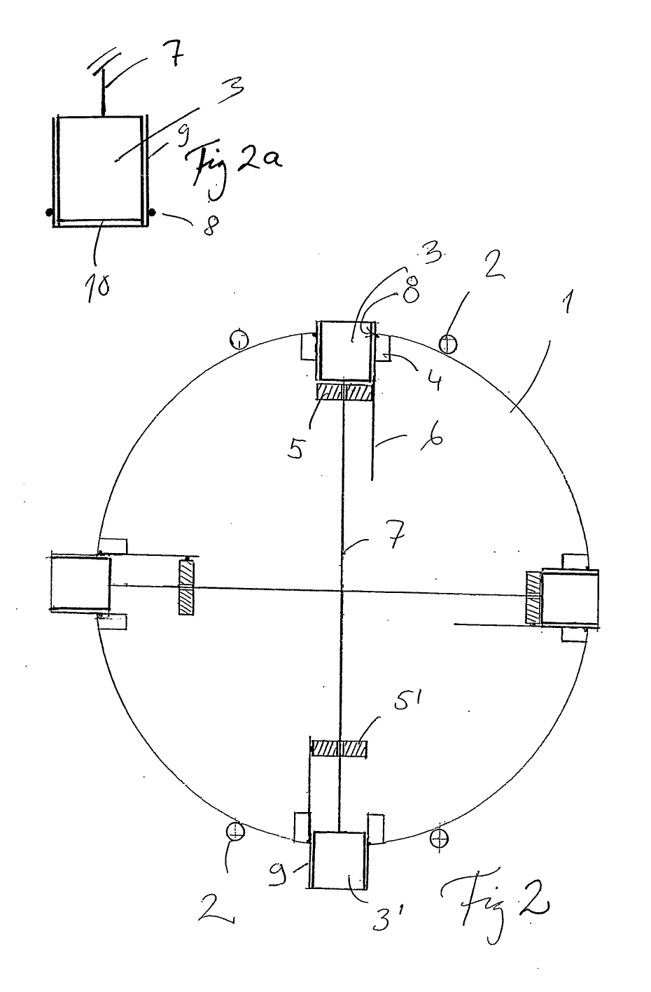

FIG. 2 shows a slightly modified form of the device of FIG. 1;

FIG. 2a shows an enlarged detail of FIG. 2;

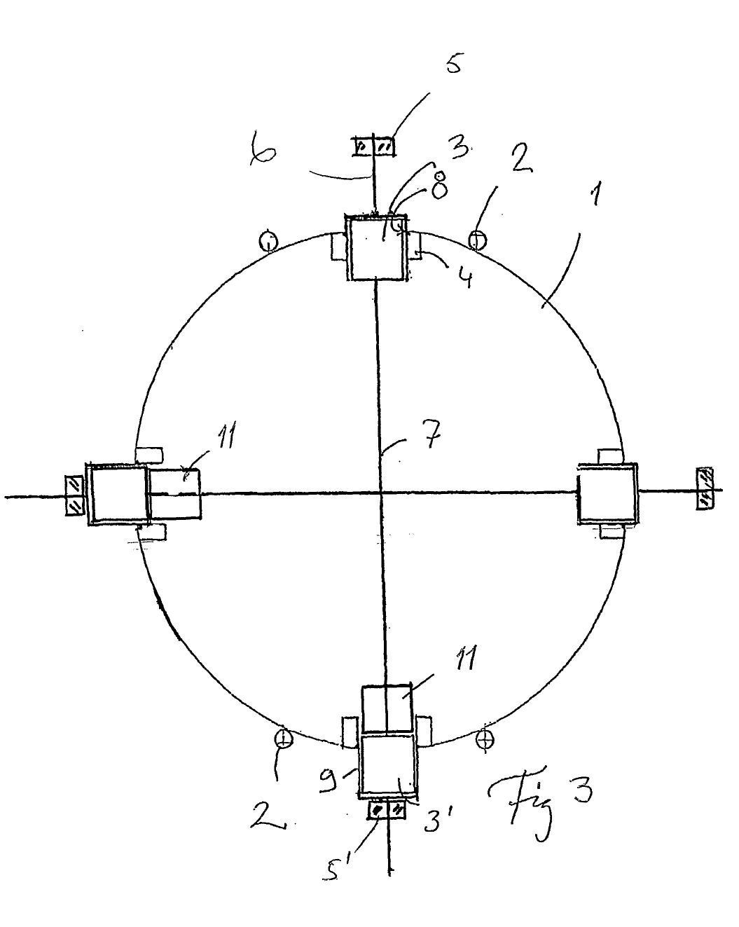

FIG. 3 shows a modified embodiment of the invention; and

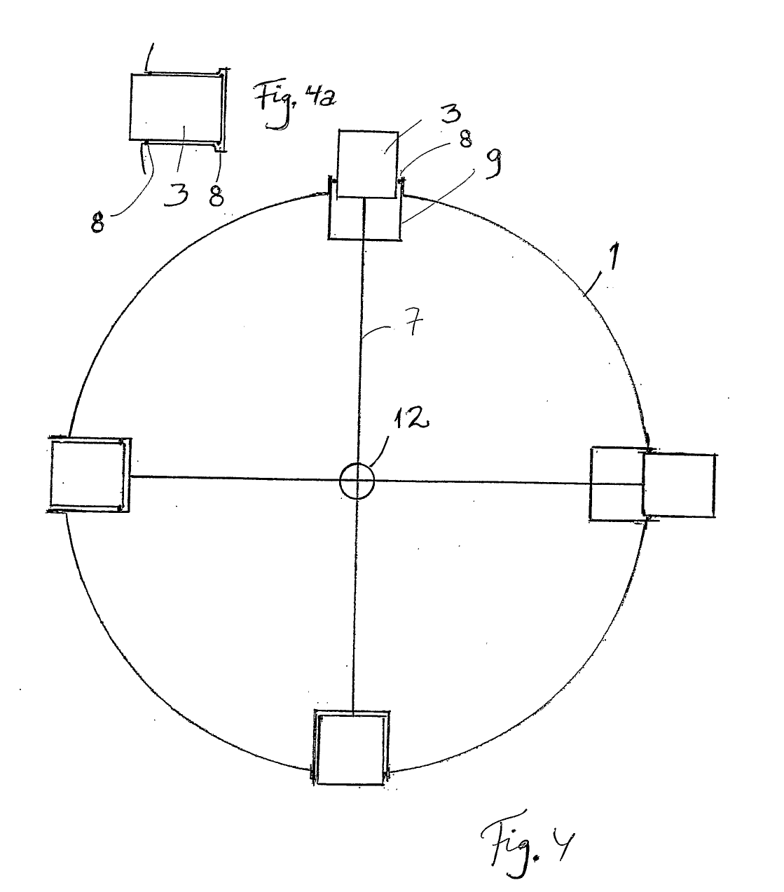

FIGS. 4 (and 4a) show yet another embodiment of the device of the invention.

The embodiment shown in the figures is, as already stated, intended to depict the basic idea of the invention, and thus it does not form a detailed depiction of the apparatus. All components that are not essential to present the basic principles of the invention have been removed from the embodiment shown in the figure.

The basic construction of the device according to the invention is a reservoir, particularly a cylinder 1, which is primarily filled at least partly, but preferably entirely with water. On the other hand, it is natural to make suitable alterations, by which the cylinder 1 can be located entirely in liquid, particularly in water, but in that case liquid is not used inside the reservoir.

In the embodiment shown in FIG. 1, the cylinder 1 is supported on suitable rollers or rolls 2. These rollers 2 are shaped in such a way that they hold the cylinder 1 in place both laterally and vertically. However, it is obvious that any known construction whatever can be used to support the cylinder, either together with the rollers 2, or even without them. It is also natural, in fact conventional, for the reservoir to be mounted on bearings at its centre, to rotate around its horizontal axis.

In this case, four sealed 8 openings are made on the circumference of the cylinder 1, through which the piston runs, guided by a guide 4. The piston 3 is connected by a rod 7 to the piston 3′ located essentially opposite the piston. The attached of the pistons 3 and 3′ to each other by the rod 7 is fixed so that the movements of the pistons are opposite; when one drops towards the centre point of the cylinder, the opposite piston correspondingly rises.

A guide 6 is attached to the circumference of the reservoir 1, and guides a weight 5. The weight 5 is positioned to slide along the guide 6, in such a way that the connecting rod 7 between the pistons runs through a hole in the weight. As such, there is no other reason for this than that the weight is thus located centrally in the apparatus and hampers the design of the construction as little as possible. In practice, there could be two guides 6, on opposite sides of the weight, for reasons of equilibrium.

FIGS. 2 (and 2a) show a modified embodiment of the apparatus of FIG. 1. The basic construction is exactly the same as in FIG. 1, but the piston 3 is now located in a separate sleeve 9 or similar that surrounds the piston 3, 3′. This difference from FIG. 1 is that the liquid, particularly water, which is inside the cylinder 1, can now penetrate between the piston 3 and the sleeve 9, which makes the operation of the device more efficient.

FIG. 2a shows a yet further improved form of the device, in which the piston 3 is also equipped with an end plate 10 and the piston can be entirely locked inside the sleeve 9 and also detached from the sleeve. In particular, it is appropriate for the locking between the piston and the sleeve to open at the 6 o'clock position (i.e. when the piston is down), so that the piston will ‘float’ for the journey from 6 o'clock to 12 o'clock, when the locking is again engaged. Thus, the buoyancy forces are effectively utilized in the apparatus according to the invention.

The figures show embodiments, in which there are two pairs of pistons 3, i.e. a total of four pistons. However, it is obvious that there can be an unlimited number of pairs of pistons and that they can be at any stage at all in 360-degree area. Indeed, it is preferable for the pairs to be at several different stages, in order to achieve even work.

From the initial situation shown in the figures, the reservoir rotates through 90 degrees, because the moments of the weights 5 and the counterweights at opposite sides of the reservoir are different and induce torque in the reservoir 1. The reservoir 1 is locked in this position. It should be noted, that for reasons of clarity the transfer or locking devices of the reservoir or other components are not shown. After locking, the locking of the piston 3 is released and the water pressure pushes the piston upwards. It is obvious that, through the rod 7, the movement also causes the opposite piston to move downwards for a corresponding distance. The work carried out by the piston is converted, using devices that are, as such, known, for recovery and possibly to form transmittable energy, such as electricity.

The weight 5′ of the lower totality is released from the locking and the weight raised, by means that are, as such, known, to the position shown in the figure, where it is locked. At the same time, the weight 5 at the uppermost position is released from the locking and raised for the next stage to the upper position, which is shown in the figure. At this stage, the locking of the reservoir is opened and the next cycle in the energy production starts. The repetition of the stages described above creates a continuous production of energy.

As has been stated, the device according to the invention also works in such a way that the device is located entirely in a water tank, but the interior of the reservoir is emptied of water. The movements are then naturally opposite to those in the previous case, as the water pressure then acts from the outside to the inside. All in all, the pistons are preferably as light as possible.

According to yet another embodiment, the weights can be entirely omitted. The device is then altered to a form, in which the movements of only the pistons are controlled together or separately. Otherwise, the device operates in the manner outlined above. The force of buoyance is exploited to produce energy.

In the embodiment shown in FIG. 3, the following changes have been made compared to the embodiment of FIG. 2; the weights 5 and 5′ have now been moved, along with their guides, to the outer circumference of the device, away from the shaft 7 of the float system, which is inside the device. However, an additional weight, which is slightly heavier than water so that it sinks in water, is located on the shafts 7.

The additional weight 11 can move over the entire length of the shaft 7. The weight can be locked in place, as stated in the following operating description and the locking can be released as desired.

The state shown in FIG. 3 arises, when the additional weight 11 has been locked in the device in the 12 o'clock position and is released from the locking, when it drops to the position shown in FIG. 3. The cylinder 3′ has also protruded from the circumference to the position shown. In this situation, both the cylinder and the weight 11 are locked in place. Otherwise, the operation is the same as that generally described above.

The intention of the additional weight is for there to be an equally large volume of water on both sides of the centre point of the device, both on the right and the left. There can be two weights, as shown in FIG. 3, or, for example, four, in which case it can be assumed that each of them will move at most as far as the middle of the shaft. Other kinds of path and numbers of weights are also possible. If desired, the weight 11 can also be slightly lighter than water, in which case an external force will naturally be required to move it. The weights can be shaped as desired. As stated above, there can be weights 5 in the device, or they can be omitted.

FIGS. 4 (and 4a) shows yet another embodiment of the device according to the invention. The device is submerged in a liquid and rotates around its shaft 12. Alternatively, it can rotate on top of rollers, as, for example, in FIG. 1. The weights 3 move is cylinders or sleeves 9. As described above, the weights are connected to each other by a connecting rod 7. If the situation in FIG. 4 is considered, it will be noticed that the weight at the 3 o'clock position is at the end of a longer arm that the weight at the 9 o'clock position, which will cause a torque force that rotates the device. The weights are locked in place in this situation.

The locking of the weight coming to the 6 o'clock position is opened and the water pressure pushes the weight at that position into its cylinder and correspondingly the weight at the 12 o'clock position out of its cylinder. This arrangement is now locked immovably. The energy from the previous stage is recovered in some suitable manner.

The weights can be detached from their connection with the rod 7/the other weight. This is particularly the case for the weight at the 9 o'clock position. The connection can then be restored on a suitable occasion.

FIG. 4a shows an alternative shape for the cylinder.

The volume of liquid between the weight and the cylinder is kept as small as possible. Also the liquid, which is in between, can also be removed if desired, for example, in the situation at the 12 o'clock position. However, when balance is kept in the apparatus, water can be left into the cylinders so that equal volumes of water is left in the opposite cylinders. So water may be left in one or more pairs of opposite cylinders.

The device according to the invention is expressly intended to produce energy. In a known manner, the energy can be recovered from the movement of the device in many different ways, for instance, by pumping, by various rotating systems, etc.

It is obvious that only some operating principles, and not the more detailed construction of the apparatus have been described above. Many variations are possible, there being no significance in terms of the totality in, for example, shape or number of the weights, pistons, or other components used. It is also obvious, that even though the operation of two pairs of units connected to each other is described for reasons of clarity, in practice there can be an unlimited number of unit pairs.

The apparatus according to the invention can also be varied by adding additional weights, floats, or other additional devices, which are used to improve its overall economy. For example, there can be several weights set one after the other. Similarly, pistons can be used in such a way that they are set one after the other (in the radial direction of the reservoir). The control of the arrangement with the aid of a computer would certainly also be sensible. Because, in certain conditions it will be necessary to move the pistons/weights in the device with the aid of external energy, it will be necessary to equip it with suitable devices for this purpose, but these are not described due to their conventionality.

If desired, the water space of the reservoir according to the invention can be divided into sections as wished. Other variations too, which are not referred to separately, are however possible, while remaining within the scope of the protection of the basic inventive idea and the accompanying Claims. For example, the pistons need not be connected to each other using a rod 7, instead each piston can be guided suitably individually, their movements being, however, essentially as described above. Also the radial position of the pistons/sleeves can differ from that shown in the figures.

It is obvious, that the movements of the pistons and cylinders relative to each other can be arranged as desired, in a sensible manner. Thus the pistons can remain stationary and the cylinders move, or vice versa. An alternative is also possible, according to which both the cylinder and the piston move as a kind of package.

1. A device for producing energy, using a reservoir filled with liquid, or submerged in liquid, and at least two moving pistons which are tightly installed in guides in the wall of the reservoir, characterized in that the reservoir is supported on rollers/rolls located against its outer surface, or on a central shaft.

2. A device according to claim 1, characterized in that there are at least two pairs of pistons.

3. A device according to claim 1, characterized in that in the immediate vicinity of each piston there is a weight that can be moved essentially in the radial direction of the reservoir.

4. A device according to claim 1, characterized in that there are two pairs of pistons and that the pistons located on different sides of the reservoir are attached to each other by means of a connecting rod.

5. A device according to claim 1, characterized in that the weight is intended to move along at least one separate guide.

6. A device according to claim 1, characterized in that the pistons are essentially cylindrical and that the piston guides are permanently attached to the jacket of the reservoir.

7. A device according to claim 1, characterized in that the reservoir is filled with a liquid, particularly water and that the reservoir is located in the atmosphere.

8. A device according to claim 1, characterized in that each piston is located in a separate sleeve-like device which is sealed around the guide so that the piston and the device are separated from each other by a gap, through which water can penetrate.

9. A device according to claim 7, characterized in that the piston and the device can be detached from each other.

10. A device according to claim 3, characterized in that the device includes, additional weights.

11. A device according to claim 1, characterized in that the device includes at least one float.
